(19) United States
(12) Patent Application Publication
(10) Pub. No.: US 2019/0011789 A1
(43) Pub. Date: Jan. 10, 2019

(54) LIQUID CRYSTAL DISPLAY PANEL AND MANUFACTURING METHOD THEREOF

(71) Applicants: HKC Corporation Limited, Shenzhen City, Guangdong (CN); Chongqing HKC Optoelectronics Technology Co., Ltd., Chongqing (CN)

(72) Inventor: Yu-Jen CHEN, Chongqing (CN)

(21) Appl. No.: 15/735,285

(22) PCT Filed: Apr. 14, 2017
(86) PCT No.: PCT/CN2017/080552

§ 371 Date: Dec. 11, 2017

(30) Foreign Application Priority Data
Dec. 29, 2016 (CN) 201611249561.0

(51) Int. Cl. G02F 1/1362; G02F 1/1368; G02F 1/1335

(52) U.S. Cl. CPC G02F 1/136209; G02F 1/1368; G02F 2001/133388; G02F 1/133528; G02F 2202/28; G02F 1/136286

(57) ABSTRACT

The invention relates to a liquid crystal display panel and manufacturing method thereof. The manufacturing method of the liquid crystal display panel comprises: providing a transparent substrate and an active switch array substrate, wherein the active switch array substrate includes an active switch array and peripheral metal wirings, the active switch array is formed on the active switch array substrate, and the peripheral metal wirings are formed on a peripheral region of the active switch array; forming a liquid crystal layer between the transparent substrate and the active switch array substrate; and forming a light-shading layer on a peripheral region of an outer surface of the active switch array substrate for shading the peripheral metal wirings.

### BACKGROUND OF THE INVENTION

### Field of Invention

The present invention generally relates to a liquid crystal display panel and manufacturing method thereof, and especially to a no-bezel design liquid crystal display panel and manufacturing method thereof.

### Description of Related Art

In recent years, with the progress of science and technology, a variety of display devices, such as a liquid crystal display (LCD) or an electroluminescence (EL) display, is widely used in a flat panel display field. Take a liquid crystal display (LCD) as an example, a backlight type LCD display is a major type of LCD display and is composed of a liquid crystal display panel and a backlight module. The liquid crystal display panel includes two transparent substrates and a plurality of liquid crystals encapsulated between the two transparent substrates.

A backlight type liquid crystal display (LCD) is gradually developed into a new type of no-bezel design for more emphasizing a whole image with overall viewing user experience. The no-bezel design is a kind of liquid crystal display (LCD) with no bezel around a display panel but will result in a serious problem of side light leakage. The problem of side light leakage should be resolved or overcome while there is no bezel disposed around the display panel. In addition, when the display panel arrays of the no-bezel liquid crystal display (LCD) devices show upward, metals around the display panel will reflect a light from the display panel to downgrade a visual effect and influence a visual quality of the liquid crystal display (LCD) products.

### SUMMARY OF THE INVENTION

For resolving the technical problems above-mentioned, the objects of the present invention are to develop a new liquid crystal display panel and manufacturing method thereof, so that the light reflected by the metal around the display panel can be reduced.

The objects and technical solutions of the present invention are implemented by following technical ways and means. In one perspective, the present invention provides a liquid crystal display panel, comprising:
a transparent substrate;
an active switch array substrate disposed oppositely to the transparent substrate, wherein the active switch array substrate includes an active switch array and peripheral metal wirings, the active switch array is formed on the active switch array substrate, and the peripheral metal wirings are formed on a peripheral region of the active switch array;
a liquid crystal layer formed between the transparent substrate and the active switch array substrate;
a polarizer formed outside of the active switch array substrate; and
a light-shading layer disposed on a peripheral region of an outer surface of the active switch array substrate for shading the peripheral metal wirings;
wherein the transparent substrate is oriented to a backlight module, and the active switch array substrate is oriented to a user.

In some embodiments of the present invention, the light-shading layer is located between the active switch array substrate and the polarizer.

In some embodiments of the present invention, the liquid crystal display panel further comprises a covering layer, wherein the covering layer is disposed on an outer surface of the polarizer.

In some embodiments of the present invention, the light-shading layer is a black material.

In some embodiments of the present invention, the black material is a black photoresist material.

In some embodiments of the present invention, the light-shading layer is a light-shading glue coated between the active switch array substrate and the polarizer, and the light-shading glue is further coated on a peripheral region of the polarizer.

In some embodiments of the present invention, the light-shading glue is coated on the peripheral metal wirings or peripheral electric components of the active switch array substrate.

In one perspective, the present invention further provides a method for manufacturing a liquid crystal display panel, comprising:
providing a transparent substrate and an active switch array substrate, wherein the active switch array substrate includes an active switch array and peripheral metal wirings, the active switch array is formed on the active switch array substrate, and the peripheral metal wirings are formed on a peripheral region of the active switch array;
forming a liquid crystal layer between the transparent substrate and the active switch array substrate;
forming a polarizer outside of the active switch array substrate; and
forming a light-shading layer on a peripheral region of an outer surface of the active switch array substrate for shading the peripheral metal wirings.

In one perspective, the present invention further provides a liquid crystal display panel, comprising:
a transparent substrate;
an active switch array substrate disposed oppositely to the transparent substrate, wherein the active switch array substrate includes an active switch array and peripheral metal wirings, the active switch array is formed on the active switch array substrate, and the peripheral metal wirings are formed on a peripheral region of the active switch array;
a liquid crystal layer formed between the transparent substrate and the active switch array substrate; and
a light-shading layer disposed on a peripheral region of an outer surface of the active switch array substrate for shading the peripheral metal wirings;
wherein the transparent substrate is oriented to a backlight module, and the active switch array substrate is oriented to a user;
wherein the light-shading layer is a light-shading glue coated between the active switch array substrate and the polarizer, the light-shading glue is further coated on a peripheral region of the polarizer, and the light-shading glue is further coated on the peripheral metal wirings or peripheral electric components of the active switch array substrate;
wherein the liquid crystal display panel further comprises a covering layer, the covering layer disposed on an outer surface of the polarizer.

The present invention can absorb and shade a light reflected from the peripheral metal wirings of the active switch array substrate, and can reduce bad visual effect resulted from reflection from the peripheral metal wirings.

### BRIEF DESCRIPTION OF THE DRAWINGS

FIG. 1 shows a structure example of a traditional liquid crystal display (LCD) with a backlight module.

FIG. 1a shows a cross-sectional view illustrating a liquid crystal display (LCD) panel array layer according to one embodiment of the present invention.

FIG. 1b shows a cross-sectional view illustrating a liquid crystal display (LCD) panel array layer with a black material under a covering layer according to one embodiment of the present invention.

FIG. 2a shows a cross-sectional view illustrating a liquid crystal display (LCD) panel array layer according to another embodiment of the present invention.

FIG. 2b shows a cross-sectional view illustrating a liquid crystal display (LCD) panel array layer with a black material on a surface of an active switch array substrate according to one embodiment of the present invention.

FIGS. 3a and 3b show various light-shading layers on an active switch array substrate and a polarizer according to embodiments of the present invention.

### DESCRIPTION OF THE PREFERRED EMBODIMENTS

The drawings as referred to throughout the description of the present invention are examples for implementing the objects of the present invention. The orientation words or terms used in the description of the present invention, such as “above”, “under”, “forward”, “backward”, “left”, “right”, “inner”, “outer”, “side”, etc. are examples in the drawings for illustrative purpose only, or just show the interrelations between the components, but not to be construed as limitations to the scope of the present invention.

The drawings and the description of the present invention are deemed to be examples but not limitations essentially. In the drawings, components or elements having similar or same structure are marked with the same numbers. In addition, sizes and thicknesses of every component or element are just examples, but not drawn according to actual scale and not read as limitations to the scope of the present invention.

In drawings of the present invention, sizes and thicknesses of layers, films, panels, or regions are emphasized for clearness, easy to describe and easy to understand. Therefore, some layers, films, or regions are emphasized but not drawn according to their actual scales. It is to be understood that, for example, when one of the components of layers, films, regions, or substrate are “on” another component of layers, films, regions, or substrate, the one of the components of layers, films, regions, or substrate could be adjacent on another component of layers, films, regions, or substrate directly, or there could be other inter-components of layers, films, regions, or substrate disposed therebetween.

Furthermore, in the description of the present invention, a word “comprising” or “including” is construed to comprise or include the related components but not exclude other components, except there is clearly opposite word or description in the present invention. And, in the description of the present invention, a word “on” is construed to be above or under a target component, but not construed to be on a top of the target component in vertical or gravity direction.

For further clarifying the technical solutions or functions of the present invention to implement the objects of the present invention, a liquid crystal display panel and manufacturing method thereof, and their specific implementations, structures, features and functions, according to a preferred embodiment of the present invention will be apparent from the following detailed description with reference to the accompanying drawings.

A liquid crystal display (LCD) includes liquid crystals disposed between two glass substrates applied with an electric field, so that a frame or numbers can be shown. The liquid crystals are composed of a kind of material between liquid and solid. The liquid crystal display (LCD) needs a backlight module for providing light, because the liquid crystal display (LCD) cannot glow itself. An image is shown by controlling the light passing through the liquid crystal display (LCD), wherein liquid crystals are disposed within the liquid crystal display (LCD) uniformly.

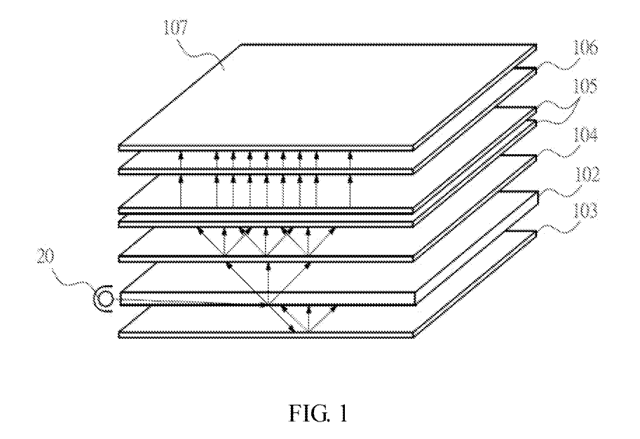

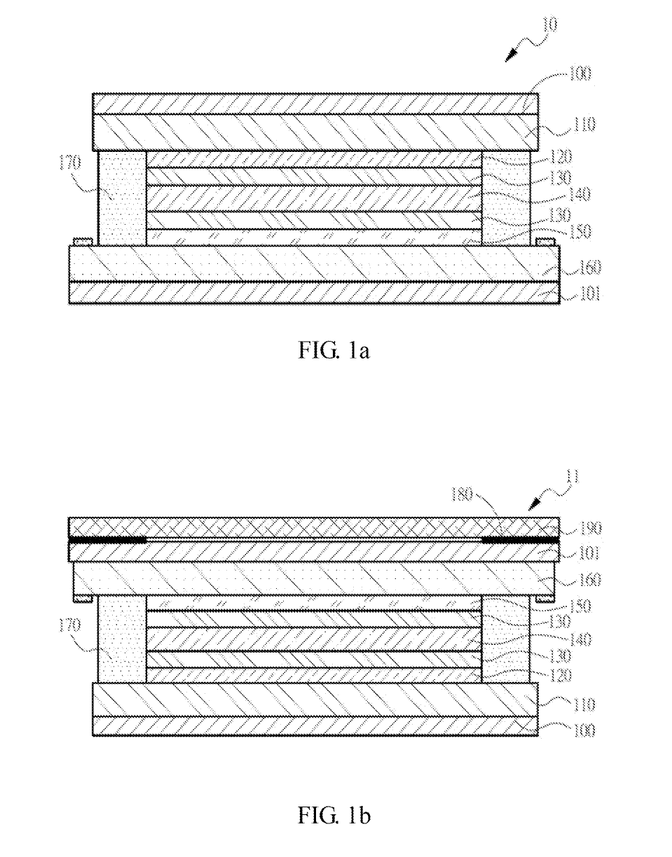

FIG. 1 shows a traditional liquid crystal display (LCD) with a backlight module. The backlight module of the liquid crystal display (LCD) comprises a light source 20, a light-guide plate 102, a reflection plate 103, a diffuser plate 104, a prism sheet 105, and a protection plate 106. First, the light source 20 is used for emitting light into the liquid crystal display (LCD). Currently, there have been a variety of light sources to be used in the liquid crystal display (LCD). The light-guide plate 102 is disposed under a liquid crystal display panel 107, and the light source 20 is near one side of the light-guide plate 102. The light-guide plate 102 is used for transforming a light from a point light source into a surface-scattering light, and the surface-scattering light is then projected on the liquid crystal display panel 107.

As shown in FIG. 1, the reflection plate 103 is disposed under the light-guide plate 102. The reflection plate 103 is used for reflecting the light emitted from the light source 20 to the liquid crystal display panel 107 located in front of the reflection plate 103. The diffuser plate 104 is disposed above the light-guide plate 102 for evening the light distribution, wherein the light is reflected from the reflection plate 103 and passes through the light-guide plate 102. When the light passes through the diffuser plate 104, the light is diffused in both horizontal direction and vertical direction. The brightness of the light is accordingly largely reduced. To resolve the problem above-mentioned, the prism sheet 105 is used for refracting and concentrating the light to improve the brightness. Generally speaking, two prism sheets 105 are used and arranged in a way of being perpendicular to each other.

Please refer to FIG. 1, the protection plate 106 is disposed above the prism sheet 105. In the foregoing situation of two perpendicular prism sheets 105, the protection plate 106 can be used for avoiding scratching on the prism sheet 105 and avoiding a Moire effect or wave effect. To sum up, a backlight module of a traditional liquid crystal display (LCD) includes the components above-mentioned.

Generally speaking, when the prism sheet 105 is disposed normally, a plurality of prism units are arranged on a transparent material film in a regular way along the same direction. The prism sheet 105 is used for refracting the light passing through the light-guide plate 102 and is diffused by the diffuser plate 104. Generally speaking, when the light transmits and is refracted through a smaller width, the light in regions of transmitting and refracted is brighter. On the contrary, when the light transmits and is refracted through a larger width, the light in regions of transmitting and being refracted is dimmer.

In some embodiments of the present invention, the light-guide plate 102 can be manufactured by injection molding technique with a material of light curable resins, Polymethylmethacrylate (PMMA), or Polycarbonate (PC), for guiding light from the light source to the liquid crystal display panel. The light-guide plate has a light exit surface, a light reflection surface and a side light incident surface. The light exit surface is formed at a side of the light-guide plate facing to the liquid crystal display panel. The light exit surface can process a matte or gloss treatment, or form point-like structures for scattering evenly the exit light from the light-guide plate to reduce a Mura effect or a non-uniform light distribution effect.

In some embodiments of the present invention, the light exit surface of the light-guide plate 102 can further comprise a plurality of protrusion structures for further correcting the light direction to condense light largely and increase brightness. The protrusion structures can be, for example, prism shaped protrusion structures or recess structures, or semicircle shaped protrusion structures or recess structures, etc. The light reflection surface is formed on another side of the light-guide plate corresponding to the side of light exit surface, for reflecting the light to the light exit surface.

In some embodiments of the present invention, the light reflection surface of the light-guide plate 102 has a plurality of light-guide structures for reflecting and guiding the light to transmit out of the light exit surface. The light-guide structures can be, for example, continuous V-shaped structures, such as V-cut structures, matte structures, point-like scattering structures, for guiding the light totally from the light source to transmit out of the light exit surface. The side light incident surface is formed on one side or two corresponding sides of the light-guide plate to correspond the light source for receiving or allowing the light transmitted from the light source into the light-guide plate. The side light incident surfaces can have, for example, V-shaped or V-cut structures, S-shaped wave structures, or roughening treatment (not shown), for improving the light incident efficiency and optical coupling efficiency.

In some embodiments of the present invention, the light source 20 can be, for example, a cold cathode fluorescent lamp (CCFL), a hot cathode fluorescent lamp (HCFL), a light-emitting diode (LED), an organic light-emitting diode (OLED), a flat fluorescent lamp (FFL), an electro-luminescence (EL) component, a light bar, a laser light source, or such a combination thereof.

In some embodiments of the present invention, the backlight module can further comprise optical films, such as a diffuser plate, a prism sheet, a turning prism sheet, a brightness enhancement film (BEF), a dual brightness enhancement film (DBEF), a diffused reflective polarizer film (DRPF), or such a combination thereof. The optical films are disposed on the light-guide plate for improving the optical effect of light exiting from the light-guide plate.

Currently, a liquid crystal display (LCD) design is gradually towards a large sized LCD panel. A new type of no-bezel LCD design is accordingly developed for maintaining light exit density beyond a predetermined level and emphasizing the whole image with overall viewing sense. When there is no bezel disposed around the display panel, the problem of side light leakage needs to be resolved or overcome. Otherwise, a peripheral light leakage effect will appear. In addition, when the display panel arrays of the no-bezel liquid crystal display (LCD) devices display upward, metals around the display panel will reflect a light from the display panel to downgrade a visual effect and influence a visual quality of the liquid crystal display (LCD) products. Therefore, it is a very important referring factor for developing a large sized LCD panel to balance light exiting uniformly and the problem of peripheral light leakage.

The liquid crystal display apparatus of the present invention comprises a backlight module and a liquid crystal display panel. The liquid crystal display panel can comprise an active switch array substrate (for example, a thin film transistor (TFT) substrate), a color filter (CF) substrate, and a liquid crystal layer disposed between the active switch array substrate and the color filter (CF) substrate.

In one embodiment of the present invention, the present liquid crystal display panel can be a curved surface type display panel, and the present liquid crystal display apparatus can also be a curved surface type display apparatus.

FIG. 1a shows a cross-sectional view illustrating a liquid crystal display (LCD) panel array layer 10 according to one embodiment of the present invention. And FIG. 1b shows a cross-sectional view illustrating a liquid crystal display (LCD) panel array layer 11 with a black material under a covering layer 190 according to one embodiment of the present invention. Please refer to FIGS. 1a and 1b, in one embodiment of the present invention, the liquid crystal display panel 11 comprises: a transparent substrate 110 having an outer surface; a first polarizer 100 disposed on the outer surface of the transparent substrate 110; an active switch array substrate 160 disposed oppositely to the transparent substrate 110, and the active switch array substrate 160 having an outer surface; a second polarizer 101 disposed on the outer surface of the active switch array substrate 160, and the second polarizer 101 having an outer surface; a liquid crystal layer 140 disposed between the transparent substrate 110 and the active switch array substrate 160; a frame glue 170 disposed between a peripheral region of the transparent substrate 110 and a peripheral region of the active switch array substrate 160, for surrounding the liquid crystal layer 140. The present invention further includes a light-shading layer 180 disposed on the peripheral region of the outer surface of the second polarizer 101. When the light-shading layer 180 disposed on the peripheral region of the outer surface of the second polarizer 101, the light-shading layer 180 is located between the second polarizer 101 and the covering layer 190.

In one embodiment of the present invention, a light spacer layer 130 is formed on a color filter patterned layer 120.

In one embodiment of the present invention, the method of forming the light-shading layer 180 and covering layer 190 includes an exposure process and a development process, or a printing process.

In one embodiment of the present invention, the method of forming an active switch array and a color filter on a substrate includes a photoresist coating process, an exposure process, a development process, and a mask process.

In one embodiment of the present invention, the light-shading layer 180 includes a black material. For example, the light-shading layer 180 can be formed by an insulating black ink. And, the light-shading layer 180 is disposed within a bezel or border region for showing a black bezel on the peripheral region of the covering layer 190. In a no-bezel liquid crystal display panel design, the light-shading layer 180 is a bezel design seemingly for achieving the object of beautifying the appearance of the present liquid crystal display panel.

In one embodiment of the present invention, the black material 180 is a black photoresist material.

In one embodiment of the present invention, the transparent substrate 110 is a color filter substrate.

In one embodiment of the present invention, the active switch array substrate 160 is a thin film transistor (TFT) substrate.

In one embodiment, the present invention further comprises a liquid crystal layer 140 disposed between the transparent substrate 110 and the active switch array substrate 160.

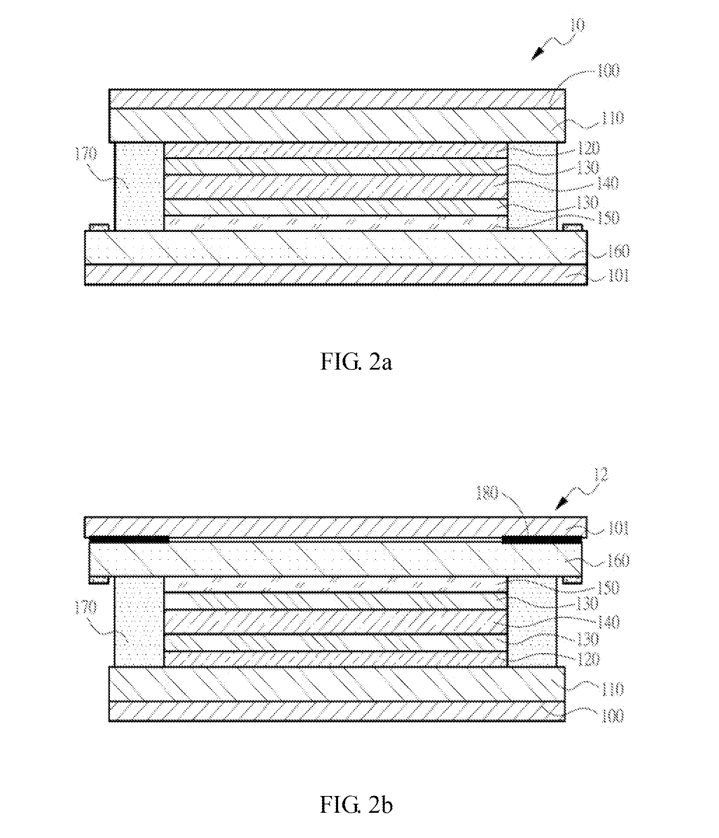

Please further refer to FIGS. 2a and 2b, wherein FIG. 2a shows a cross-sectional view illustrating a liquid crystal display (LCD) panel array layer 10 according to another embodiment of the present invention, and FIG. 2b shows a cross-sectional view illustrating a liquid crystal display (LCD) panel array layer 12 with a black material on a surface of an active switch array substrate according to one embodiment of the present invention. Please refer to FIGS. 2a and 2b, in one embodiment of the present invention, the liquid crystal display panel 12 comprises: a transparent substrate 110 having an outer surface; a first polarizer 100 disposed on the outer surface of the transparent substrate 110; an active switch array substrate 160 disposed oppositely to the transparent substrate 110, and the active switch array substrate 160 having an outer surface; a second polarizer 101 disposed on the outer surface of the active switch array substrate 160, and the second polarizer 101 having an outer surface; a liquid crystal layer 140 disposed between the transparent substrate 110 and the active switch array substrate 160; a frame glue 170 disposed between a peripheral region of the transparent substrate 110 and a peripheral region of the active switch array substrate 160, for surrounding the liquid crystal layer 140. The present invention further includes a light-shading layer 180 disposed on the peripheral region of the outer surface of the active switch array substrate 160. When the light-shading layer 180 disposed on the peripheral region of the outer surface of the active switch array substrate 160, the light-shading layer 180 is located between the active switch array substrate 160 and the second polarizer 101.

In one embodiment of the present invention, the method of forming the light-shading layer 180 includes an exposure process and a development process, or a printing process.

In one embodiment of the present invention, the method of forming the transparent substrate 110 and the active switch array substrate 160 includes a photoresist coating process, an exposure process, a development process, and a mask process.

In one embodiment of the present invention, the light-shading layer 180 includes a black material. For example, the light-shading layer 180 can be formed by an insulating black ink. And, the light-shading layer 180 is disposed within a bezel or border region for showing a black bezel on the peripheral region of the covering layer 190. In a no-bezel liquid crystal display panel design, the light-shading layer 180 is a bezel design seemingly for achieving the object of beautifying the appearance of the present liquid crystal display panel.

In one embodiment of the present invention, the black material 180 is a black photoresist material.

In one embodiment of the present invention, the transparent substrate 110 is a color filter substrate.

In one embodiment of the present invention, the active switch array substrate 160 is a thin film transistor (TFT) substrate.

In one embodiment, the present invention includes a liquid crystal layer 140 disposed between the transparent substrate 110 and the active switch array substrate 160.

In some embodiments of the present invention, the color filter (CF) and the thin film transistor (TFT) can be formed on the same substrate.

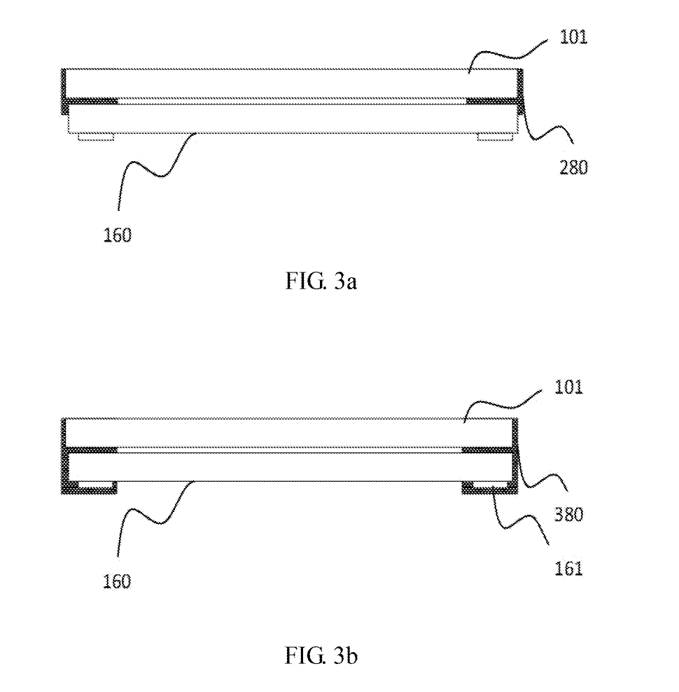

Please refer to FIG. 3a, in one embodiment of the present Invention, a light-shading layer 280 can be a light-shading glue coated between the active switch array substrate 160 and the second polarizer 101. In addition, the light-shading glue can further be coated on sidewalls and a peripheral region of the second polarizer 101 to avoid the second polarizer 101 peeled off.

Furthermore, please refer to FIG. 3b, in one embodiment of the present Invention, a light-shading layer 380 can be a light-shading glue coated between the active switch array substrate 160 and the second polarizer 101. And the light-shading glue can be coated on sidewalls and a peripheral region of the second polarizer 101 to avoid the second polarizer 101 peeled off. In addition, the light-shading glue can further be coated on sidewalls and peripheral metal wirings and peripheral electric components of the active switch array substrate 160 to further seal the peripheral metal wirings and the peripheral electric components of the active switch array substrate 160.

Please refer to FIGS. 2a, 2b, 3a and 3b, the present invention further provides a manufacturing method for liquid crystal display panel comprises: providing and an active switch array substrate, wherein the active switch array substrate 160 comprises an active switch array 150 and peripheral metal wirings 161, the active switch array 150 is formed on the active switch array substrate 160, and the peripheral metal wirings 161 are formed on a peripheral region of the active switch array 150; forming a liquid crystal layer 140 between a transparent substrate 110 and the active switch array substrate 160; and forming a light-shading layer on a peripheral region of an outer surface of the active switch array substrate 160 for shading the peripheral metal wirings 161.

The present invention can shade a light reflected from the peripheral metal wirings 161 of the active switch array substrate 160, and can reduce bad visual effect resulted from reflection from the peripheral metal wirings 161.

“In some embodiments of the present invention” and “In a variety of embodiments of the present invention” are used repeatedly through the description. They usually mean different embodiments. However, they can also mean the same embodiments. “Comprising”, “having” and “including” are synonyms, except it is noted to be different or has other meaning before and after its description.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment

What is claimed is:

1. A liquid crystal display panel, comprising:
a transparent substrate;
an active switch array substrate disposed oppositely to the transparent substrate, wherein the active switch array substrate includes an active switch array and peripheral metal wirings, the active switch array is formed on the active switch array substrate, and the peripheral metal wirings are formed on a peripheral region of the active switch array;
a liquid crystal layer formed between the transparent substrate and the active switch array substrate;
a polarizer formed outside of the active switch array substrate; and
a light-shading layer disposed on a peripheral region of an outer surface of the active switch array substrate for shading the peripheral metal wirings;
wherein the transparent substrate is oriented to a backlight module, and the active switch array substrate is oriented to a user.

2. The liquid crystal display panel according to claim 1, wherein the light-shading layer is located between the active switch array substrate and the polarizer.

3. The liquid crystal display panel according to claim 2, further comprising a covering layer, the covering layer disposed on an outer surface of the polarizer.

4. The liquid crystal display panel according to claim 1, wherein the light-shading layer is a black material.

5. The liquid crystal display panel according to claim 4, wherein the black material is a black photoresist material.

6. The liquid crystal display panel according to claim 1, wherein the light-shading layer is a light-shading glue coated between the active switch array substrate and the polarizer, and the light-shading glue is further coated on a peripheral region of the polarizer.

7. The liquid crystal display panel according to claim 6, wherein the light-shading glue is coated on the peripheral metal wirings or peripheral electric components of the active switch array substrate.

8. A method of manufacturing a liquid crystal display panel, comprising:
providing a transparent substrate and an active switch array substrate, wherein the active switch array substrate includes an active switch array and peripheral metal wirings, the active switch array is formed on the active switch array substrate, and the peripheral metal wirings are formed on a peripheral region of the active switch array;
forming a liquid crystal layer between the transparent substrate and the active switch array substrate;
forming a polarizer outside of the active switch array substrate; and
forming a light-shading layer on a peripheral region of an outer surface of the active switch array substrate for shading the peripheral metal wirings.

9. The method according to claim 8, wherein the light-shading layer is located between the active switch array substrate and the polarizer.

10. The method according to claim 9, wherein the liquid crystal display panel further comprises a covering layer, the covering layer disposed on an outer surface of the polarizer.

11. The method according to claim 8, wherein the light-shading layer is a black material.

12. The method according to claim 11, wherein the black material is a black photoresist material.

13. The method according to claim 8, wherein the light-shading layer is a light-shading glue coated between the active switch array substrate and the polarizer, and the light-shading glue is further coated on a peripheral region of the polarizer.

14. The method according to claim 13, wherein the light-shading glue is coated on the peripheral metal wirings or peripheral electric components of the active switch array substrate.

15. A liquid crystal display panel, comprising:
a transparent substrate;
an active switch array substrate disposed oppositely to the transparent substrate, wherein the active switch array substrate includes an active switch array and peripheral metal wirings, the active switch array is formed on the active switch array substrate, and the peripheral metal wirings are formed on a peripheral region of the active switch array;
a liquid crystal layer formed between the transparent substrate and the active switch array substrate;
a polarizer formed outside of the active switch array substrate; and
a light-shading layer disposed on a peripheral region of an outer surface of the active switch array substrate for shading the peripheral metal wirings;
wherein the transparent substrate is oriented to a backlight module, and the active switch array substrate is oriented to a user;
wherein the light-shading layer is a light-shading glue coated between the active switch array substrate and the polarizer, the light-shading glue is further coated on a peripheral region of the polarizer, and the light-shading glue is further coated on the peripheral metal wirings or peripheral electric components of the active switch array substrate;
wherein the liquid crystal display panel further comprises a covering layer, the covering layer disposed on an outer surface of the polarizer;
wherein the transparent substrate is a color filter substrate, and the active switch array substrate is a thin film transistor (TFT) substrate.
